(19) United States
(12) Patent Application Publication
(10) Pub. No.: US 2017/0043869 A1
(43) Pub. Date: Feb. 16, 2017

(54) PROTECTION ELEMENT AND DEVICE FOR CAMERA DRONE

(71) Applicants: INTELLITRAX, INC., NEWTON, AL (US); GEORGE TANG INDUSTRIAL CORP., MIAOLI COUNTY (TW)

(72) Inventors: RICHIE HOWARD, NEWTON, AL (US); GEORGE TANG, MIAOLI COUNTY (TW)

(21) Appl. No.: 14/823,038

(22) Filed: Aug. 11, 2015

(51) Int. Cl. B64C 39/02; B64D 47/08; B64C 27/08

(52) U.S. Cl. CPC B64C 39/024; B64C 27/08; B64D 47/08; B64C 2201/024; B64C 2201/108; B64C 2201/123

(57) ABSTRACT

A protection element and a protection device for a camera drone are disclosed herein. The protection element is installed between a landing gear and a propeller of the camera drone and comprises a fixing bracket joined to a brace of the propeller and positioned between the landing gear and the propeller; a protection ring positioned around the exterior of the fixing bracket; and at least one buffer stick joined to the fixing bracket and the protection ring. The protection elements may also be installed on a camera drone having more than two propellers to function as a protection device for the camera drone. While an unpracticed user operates a camera drone, the present invention can protect the propellers of the camera drone flying in a narrow space from directly bumping into a foreign object preventing the camera drone from crashing.

### BACKGROUND OF THE INVENTION

Field of the Invention

The present invention relates to a protection element for a camera drone and a protection device for a camera drone with at least two propellers, particularly a protection element having a protection ring and buffer sticks to protect a propeller of a camera drone from property or personal injury and a protection device containing the protection elements.

Description of the Related Art

With advance of science and technology, unmanned aerial vehicles (UAV), which are also called drones, usually replace large-sized aircrafts to investigate environments. The most common application case of UAV is: a remotely piloted helicopter equipped with a camera device, i.e. the so-called camera drone, is used to investigate a small area or a narrow space hard to access, whereby to acquire images on the spot in realtime and save a great amount of fuel and personnel cost that a large-sized aircraft would consume. Although the technology of fabricating large-sized aircrafts has been mature, adverse weather conditions or sudden mechanical malfunction may endanger the crew and the passengers on board. Therefore, it is hard to completely guarantee the safety of the crew and the passengers of aircrafts.

The propellers of a conventional camera drone are very likely to bump into a foreign object if the user operates it inappropriately or it flies in a narrow space. In such a case, the camera drone will lose balance and crash, endangering the people and properties in the air or on the ground. Besides, the camera drone itself would be seriously damaged.

In order to solve the abovementioned problems, the present invention proposes a protection element and a protection device to protect propellers of camera drones and enhance the flight safety of camera drones.

### SUMMARY OF THE INVENTION

The primary objective of the present invention is to provide a protection element for a camera drone, which is arranged between a landing gear and a propeller of the camera drone and uses a protection ring to protect the propeller of the camera drone. While the camera drone is flying horizontally and may bump into a foreign object, the protection ring will collide with the foreign object beforehand, protecting the propeller and protects the camera drone from crashing. Thus, the flight safety of the camera drone is enhanced.

Another objective of the present invention is to provide a protection device for a camera drone. While a camera drone has at least two propellers, protection elements are respectively installed on the landing gear and secured by elastic fixing strips. The protection elements and the elastic fixing strips jointly form the protection device to protect the propellers of the camera drone and enhance the flight safety of the camera drone.

In order to achieve the abovementioned objectives, the present invention proposes a protection element for a camera drone, which is arranged between a landing gear and a propeller of the camera drone and includes a fixing bracket connected with the brace of the propeller and arranged between the landing gear and the propeller, a protection ring annularly disposed around the exterior of the fixing bracket, and at least one buffer stick connected with the fixing bracket and the protection ring.

In order to achieve the abovementioned objectives, the present invention also proposes a protection device for a camera drone, which is installed in a camera drone having at least two propellers, and which comprises at least two protection elements.

Below, embodiments are described in detail in cooperation with attached drawings to make easily understood the objectives, technical contents, characteristics and accomplishments of the present invention.

### BRIEF DESCRIPTION OF THE DRAWINGS

FIG. 1 is a perspective view schematically showing a protection element for a camera drone according to one embodiment of the present invention;

FIG. 2 is a perspective view schematically showing the installation position of a protection element for a camera drone according to one embodiment of the present invention;

FIG. 3 is a perspective view schematically showing a first fixing method of a protection element for a camera drone according to one embodiment of the present invention;

FIG. 4 is a perspective view schematically showing a second fixing method of a protection element for a camera drone according to one embodiment of the present invention; and

FIG. 5 is a perspective view schematically showing a protection device for a camera drone according to one embodiment of the present invention.

### DETAILED DESCRIPTION OF THE INVENTION

Based on the advancement of science and technology, unmanned aerial vehicles or drones (such as remotely controlled helicopters or small-sized aircrafts) and the owners thereof are growing persistently. For photography, research or work, more and more users equip a drone with a camera or other devices to form a camera drone, which is more expensive than a remotely controlled aircraft for amusement. The present invention is installed on a camera drone to enhance the flight safety of the camera drone.

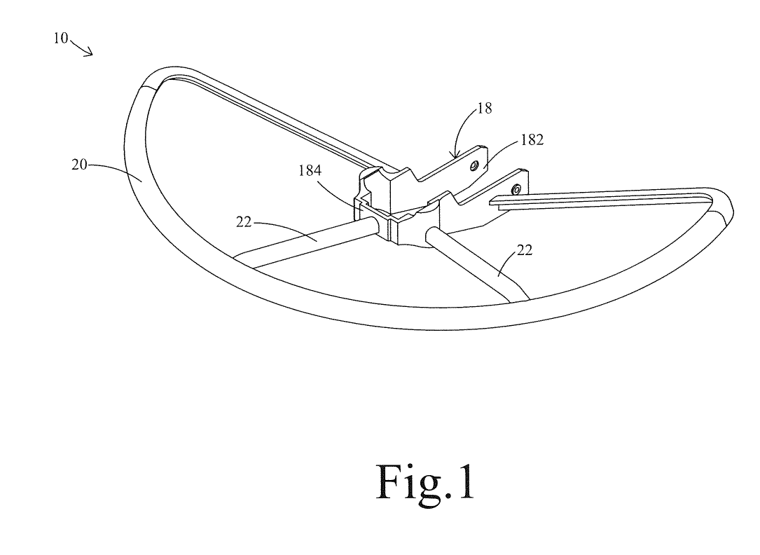

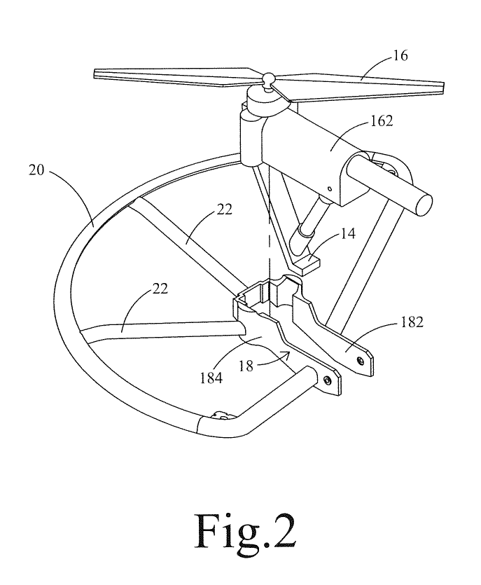

Refer to FIG. 1 and FIG. 2. The protection element 10 for a camera drone of the present invention is installed between a landing gear 14 and a propeller 16 of the camera drone and comprises a fixing bracket 18, a protection ring 20 and at least one buffer stick 22. In one embodiment, the fixing bracket 18, the protection ring 20 and the buffer sticks 22 are fabricated into a one-piece component and made of polypropylene (PP).

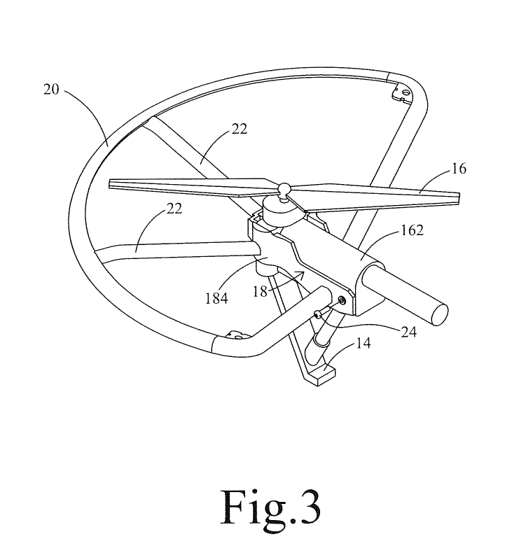

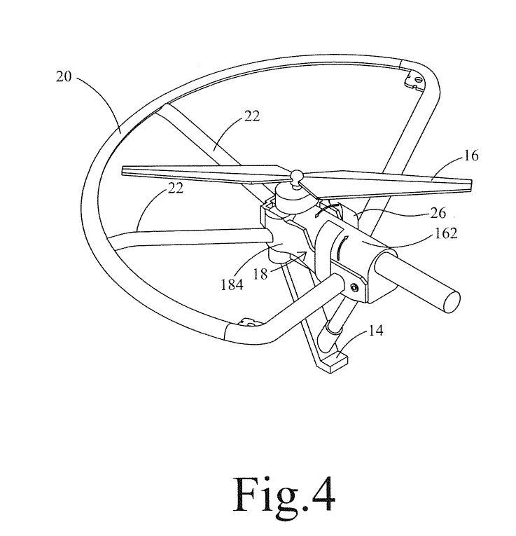

The fixing bracket 18 is joined with a brace 162 of the propeller 16 and disposed between the landing gear 14 and the propeller 16. In one embodiment, the fixing bracket 18 is a U-shape structure; the interior of an opening 182 of the fixing bracket 18 is joined with the brace 162 of the propeller 16; the protection ring 20 is annularly positioned around the exterior of the opening 182 of the fixing bracket 18; the buffer stick 22 is connected with the protection ring 20 and another side 184 of the fixing bracket 18. In the embodiment shown in FIG. 1 and FIG. 2, the protection element 10 has two pieces of buffer sticks 22. Refer to FIG. 3. A fixing element is used to join the fixing bracket 18 with the brace 162 of the propeller 16 of the camera drone 12. In the embodiment shown in FIG. 3, the fixing element is a screw 24. Refer to FIG. 4, wherein the fixing element is a hook-and-loop fastener 26.

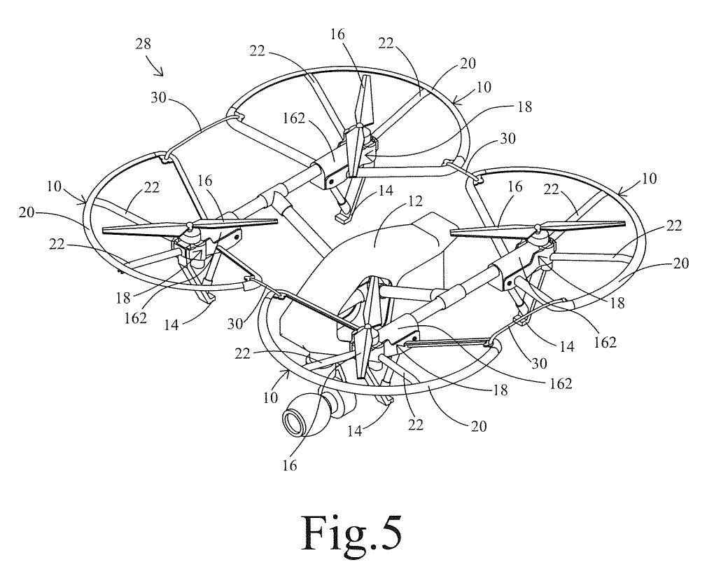

Refer to FIG. 5. After the description of the structure and installation of the protection element 10 of the present invention, a protection device 28 for a camera drone 12 of the present invention will be described below. In the embodiment shown in FIG. 5, the camera drone 12 has at least two propellers 16. Thus, the protection device 28 for the camera drone 12 comprises at least two protection elements 10 and at least one elastic fixing strip 30. In the embodiment where the camera drone 12 has at least two propellers 16 and at least two landing gears 14 corresponding to the propellers 16, the camera drone 12 is equipped with at least two protection elements 10. The installation method and installation position of each protection element 10 has been described above and will not repeat herein. At least one elastic fixing strip 30 is used to connect at least two protection elements 10 each disposed between the propeller 16 and the corresponding landing gear 14 of the camera drone 12. In the embodiment shown in FIG. 5, the camera drone 12 has four propellers 16 and four landing gears 14; each group of the propeller 16 and the landing gear 14 has one protection element 10 installed therebetween; one elastic fixing strip 30 connects the protection ring 20 of one protection element 10 with the protection ring 20 of the adjacent protection element 10; one end of the elastic fixing element 30 is joined to the protection ring 20 of one protection element 10, and the other end of the elastic element 30 is joined to the protection ring 20 of the adjacent protection element 10.

Refer to FIG. 1 and FIG. 5 again. In one embodiment, the fixing bracket 18, the protection ring 20 and the buffer sticks 22 of the protection element 10 are fabricated into a one-piece component and made of polypropylene (PP), whereby the protection element 10 is tough and lightweight, and whereby the weight of the camera drone 12 is only increased slightly, and whereby the horizontal flight of the camera drone 12 is affected inappreciably. The area encircled by the protection ring 20 of the protection element 10 is larger that the area swept by the propeller 16, whereby the protection ring 20 would collide with a foreign object before the camera drone 12 flying horizontally bumps into the foreign object. Further, the buffer sticks 22 make the protection ring 20 less likely to be recessed or distorted. Therefore, the propellers 16 of the flying camera drone 12 can be effectively protected. While the camera drone 12 has more than two propellers 16, the elastic fixing strips 30 and the protection elements 10 jointly form the protection device 28 to protect each propeller 16, enhance the flight safety, decrease the crash risk, and reduce the maintenance cost for the camera drone 12.

The embodiments have been described above to demonstrate the technical thought and characteristics of the present invention and enable the persons skilled in the art to understand, make, and use the present invention. However, these embodiments are only to exemplify the present invention but not to limit the scope of the present invention. Any equivalent modification or variation according to the spirit of the present invention is to be also included within the scope of the present invention.

What is claimed is:

1. A protection element for a camera drone, installed between a landing gear and a propeller of said camera drone, and comprising a fixing bracket joined with a brace of said propeller of said camera drone and disposed between said landing gear and said propeller;
a protection ring disposed around exterior of said fixing bracket; and
at least one buffer stick joined with said fixing bracket and said protection ring.

2. The protection element for a camera drone according to claim 1, wherein said fixing bracket, said protection ring and said buffer stick are fabricated into a one-piece component.

3. The protection element for a camera drone according to claim 1, wherein at least one fixing element is used to join said fixing bracket to said brace of said propeller of said camera drone.

4. The protection element for a camera drone according to claim 3, wherein said fixing element is a screw.

5. The protection element for a camera drone according to claim 3, wherein said fixing element is a binding strip having a hook-and-loop fastener.

6. The protection element for a camera drone according to claim 1, wherein said fixing bracket, said protection ring and said buffer stick are made of polypropylene (PP).

7. The protection element for a camera drone according to claim 1, wherein said fixing bracket is a U-shape structure.

8. The protection element for a camera drone according to claim 7, wherein interior of an opening of said fixing bracket is joined to said brace of said propeller, and wherein exterior of said opening of said fixing bracket is joined to said protection ring, and wherein exterior of another side of said fixing bracket, which is opposite said opening, is joined with said at least one buffer stick.

9. A protection device for a camera drone, installed in a camera drone having at least two propellers, and comprising at least two protection elements stated in claim 1.

10. The protection device for a camera drone according to claim 9 further comprising at least one elastic fixing strip, wherein said elastic fixing strip connects said two protection elements, and wherein said two protection elements are simultaneously positioned between said landing gears and said propellers.

11. The protection device for a camera drone according to claim 10, wherein one end of said elastic fixing strip is joined to said protect ring of one said protection element, and wherein another end of said elastic fixing strip is joined to said protection ring of another said protection element.
